(19) United States
(12) Patent Application Publication
(10) Pub. No.: US 2007/0117506 A1
(43) Pub. Date: May 24, 2007

(54) Dual mode DMB terminal capable of simultaneously receiving satellite DMB and terrestrial DMB

(75) Inventors: Joon-Ho Park, Suwon-si (KR); Young-Jip Kim, Suwon-si (KR); Jeong-Sik Cho, Suwon-si (KR); Sun-Mi Kim, Seoul (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/475,618

(22) Filed: Jun. 27, 2006

(30) Foreign Application Priority Data
Jun. 28, 2005 (KR) 56255/2005

(51) Int. Cl. H04H 1/00

(52) U.S. Cl. 455/3.01; 455/3.06; 455/12.1

(57) ABSTRACT

A dual mode Digital Multimedia Broadcasting (DMB) terminal for simultaneously receiving signals of satellite and terrestrial DMB broadcasting stations includes a satellite DMB receiver for receiving and demodulating the satellite signals, and outputting a satellite MPEG 2-TS, and another receiver for analogously processing terrestrial signals. A classification unit switches the two types of MPEG 2-TSs, and outputs the switched MPEG 2-TS to a broadcasting information display unit or an MPEG 2-TS output unit. The first unit generates TAG information, and inserts it into the MPEG 2-TS. A storage unit saves the MPEG 2-TS. The MPEG 2-TS output unit decodes and outputs the MPEG 2-TS. A controller transfers selection information for a switching operation of the DMB classification unit, and transfers information on a decoding scheme.

### CLAIM OF PRIORITY

This application claims priority to an application entitled “Dual Mode DMB Terminal Capable of Simultaneously Receiving Satellite DMB and Terrestrial DMB,” filed in the Korean Intellectual Property Office on Jun. 28, 2005 and assigned Serial No. 2005-56255, the contents of which are incorporated by reference.

### BACKGROUND OF THE INVENTION

1. Field of the Invention

The present invention relates to a DMB terminal, and more particularly to a dual mode DMB terminal capable of simultaneously receiving a satellite DMB and a terrestrial DMB.

2. Description of the Related Art

A Digital Multimedia Broadcasting (DMB) service provides a portable receiver or a vehicle receiver with various multimedia signals including voice, images, etc., in a digital format. The DMB may be classified into satellite DMB and terrestrial DMB, according to transmission means of the multimedia signals. The satellite DMB provides programs to DMB terminals throughout the nation through satellite electric waves, and the terrestrial DMB provides broadcasting through public VHF channels 12 and 8.

FIG. 1 is a block diagram illustrating the general construction of a satellite DMB system.

The satellite DMB system as illustrated in FIG. 1 includes a DMB broadcasting center 101, a DMB broadcasting transmission center 102, a DMB satellite 103, a DMB mobile communication terminal 104, a vehicle-mounted terminal 105, and a shadow area gap filler 106. The DMB broadcasting center 101 converts broadcasting content into broadcasting signals (i.e. Code Division Multiple Access (CDMA) and Time Division/Domain Multiple Access (TDMA) broadcasting signals)) in order to provide users with the broadcasting content, and the DMB broadcasting transmission center 102 receives the broadcasting signals from the DMB broadcasting center 101 and transmits the received broadcasting signals to the DMB satellite 103. The DMB satellite 103 receives the broadcasting signals from the DMB broadcasting transmission center 102 and retransmits the broadcasting signals, and the DMB mobile communication terminal 104 receives the broadcasting signals and outputs the broadcasting signals to users. The shadow area gap filler 106 retransmits the broadcasting signals to a shadow area.

In particular, the DMB broadcasting transmission center 102 transmits the broadcasting signals to the DMB satellite 103 through a Ku-band (13 GHz), and the DMB satellite 103 transmits circularly polarized wave CDMA signals to the DMB mobile communication terminal 104 and the vehicle-mounted terminal 105, which are satellite DMB receivers, through an S-band (2.6 GHz).

The DMB satellite 103 transmits linearly polarized wave TDMA signals to the shadow area gap filler 106 through a Ku-band (12 GHz). The shadow area gap filler 106 converts the linearly polarized wave TDMA signals into the circularly polarized wave CDMA signals, and transmits the circularly polarized wave CDMA signals to the DMB mobile communication terminal 104 and the vehicle-mounted terminal 105 through the S-band (2.6 GHz). The shadow area gap filler 106 is used in order to transmit signals to a shadow area which satellite signals cannot directly reach.

However, a terrestrial DMB transfers broadcasting signals through a base station such as a terrestrial broadcasting station. A terrestrial DMB conforming to the technical standard of “Eureka-147” standardized in Europe uses an Orthogonal Frequency Division Multiplexing (OFDM) transmission scheme, which is tolerant to multipath fading (characteristic of a mobile environment transmission channel) and can receive signals without deterioration of performance, in order to stably provide various services while in motion. Further, a terrestrial DMB employs a Moving Picture Expert Group (MPEG) 4 compression scheme which has excellent compression efficiency, rather than the MPEG 2 scheme of a satellite digital television. As in the case of the satellite DMB, the terrestrial DMB requires a separate gap filler to be installed in a shadow area.

According to prior art, since there is no receiver capable of simultaneously receiving a satellite DMB and a terrestrial DMB, at any given moment only one of the satellite DMB content and the terrestrial DMB content is received, according to the characteristics of a transmission medium for transmitting DMB contents.

In order to simultaneously receive a satellite DMB and a terrestrial DMB, it is necessary to provide two tuners, two demodulators, two demuxes, and two decoders. Although such a design enables simultaneous presentation or recording functions to be performed, it is costly. Moreover, the DMB device is portable and has a single LCD screen not suitable for simultaneously watching two programs.

### SUMMARY OF THE INVENTION

The present invention has been made to solve the above-mentioned problems occurring in the prior art, and an object of the present invention is to provide a dual mode DMB terminal which can receive various DMB contents transmitted through satellite and terrestrial waves regardless of a transmission medium by integrating a receiver for a receiving a satellite DMB and a receiver for a receiving a terrestrial DMB into a single receiver, and can present, i.e., play or render, one program of satellite and terrestrial DMB programs and record the other program by means of the demux and the decoder of the integrated receiver.

In one aspect of the present invention, a dual mode DMB terminal is capable of simultaneously receiving broadcasting signals of a satellite DMB and broadcasting signals of a terrestrial DMB. The terminal includes a satellite DMB receiver for receiving and demodulating the broadcasting signals of the satellite DMB, and outputting a first MPEG 2-TS generated by demodulating the broadcasting signals. A terrestrial DMB receiver receives and demodulates the broadcasting signals of the terrestrial DMB, and outputs a second MPEG 2-TS generated by demodulating the broadcasting signals. A DMB classification unit receives the first MPEG 2-TS from the satellite DMB receiver, the second MPEG 2-TS from the terrestrial DMB receiver, and switching the first MPEG 2-TS and the second MPEG 2-TS according to user selection. The DMB classification unit outputs the switched MPEG 2-TS to at least one of a broadcasting information display unit and an MPEG 2-TS output unit. The broadcasting information display unit generates TAG information according to whether the MPEG 2-TS input from the DMB classification unit is the first MPEG 2-TS or the second MPEG 2-TS, and inserts the TAG information into the MPEG 2-TS. A storage unit receives the MPEG 2-TS including the TAG information from the broadcasting information display unit, and stores the MPEG 2-TS. The MPEG 2-TS output unit decodes the MPEG 2-TS input from the DMB classification unit according to whether the input MPEG 2-TS is the first MPEG 2-TS or the second MPEG 2-TS, and outputs the decoded MPEG 2-TS. A controller transfers selection information of the user to the DMB classification unit, causing the DMB classification unit to perform a switching operation, and transfers information on a decoding scheme to the MPEG 2-TS output unit according to the switching operation.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating the general construction of a satellite DMB system;

FIG. 2 is a block diagram illustrating an example of a dual mode DMB terminal capable of simultaneously receiving a satellite DMB and a terrestrial DMB according to an embodiment of the present invention;

FIG. 3 is a diagram illustrating an exemplary configuration of an MPEG 2-TS including TAG information according to the present invention;

FIGS. 4A and 4B are flow diagrams illustrating, according to one embodiment, a method for simultaneously presenting and recording a satellite DMB and a terrestrial DMB received in a DMB terminal according to the present invention;

FIGS. 5A and 5B are exemplary views illustrating a DMB recording menu screen in a DMB terminal according to one embodiment of the present invention;

FIG. 6 is a flow diagram illustrating, by way of example, a process for presenting an MPEG 2-TS stored in a storage unit according to the present invention;

FIGS. 7A and 7B are exemplary views illustrating a menu provided by the DMB terminal in order to present an MPEG 2-TS stored in the storage unit of FIG. 6 according to one embodiment of the present invention;

FIG. 8 is a flow diagram illustrating one example of a process for finding link information of the same program in a satellite DMB and a terrestrial DMB and providing link information to a user according to the present invention; and

FIG. 9 is an exemplary view illustrating link information of the same program in the satellite DMB system and the terrestrial DMB system of FIG. 8.

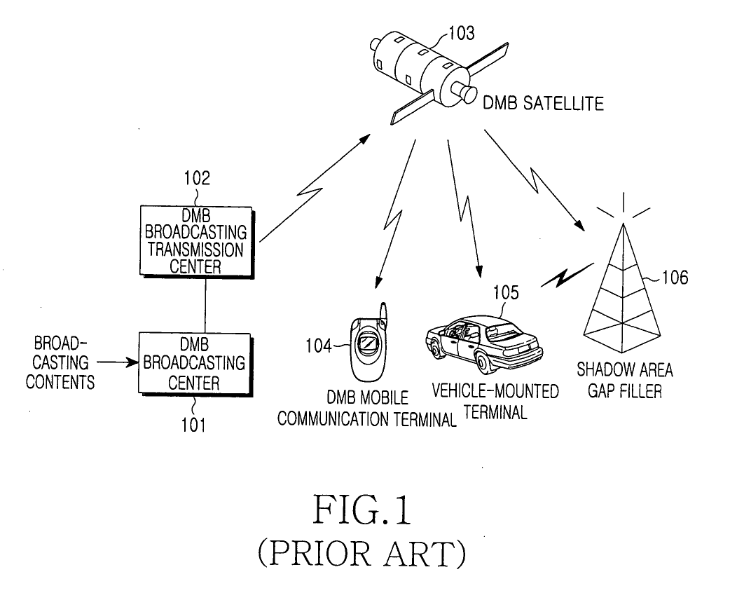

### DETAILED DESCRIPTION

An embodiment of the present invention is described in detail herein below with reference to the accompanying drawings. It should be noted that the similar components are designated by similar reference numerals although they are illustrated in different drawings. For the purposes of clarity and simplicity, detailed description of known functions and configurations incorporated herein is omitted for conciseness and clarity of presentation.

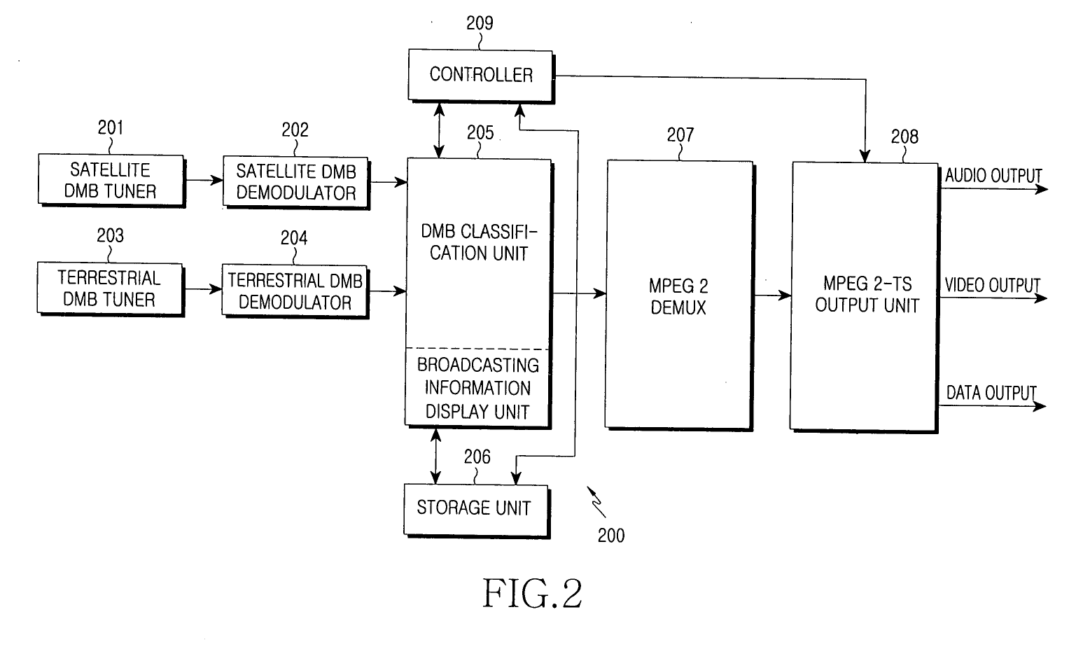

FIG. 2 is a block diagram illustrating a dual mode DMB terminal 200 capable of simultaneously receiving a satellite DMB signal and a terrestrial DMB signal according to an embodiment of the present invention.

The dual mode DMB terminal 200 includes a satellite DMB tuner 201, a satellite DMB demodulator 202, a terrestrial DMB tuner 203, a terrestrial DMB demodulator 204, a DMB classification unit 205, a storage unit 206, an MPEG 2 demux 207, an MPEG 2-TS (Transport Stream) output unit 208, and a controller 209. The satellite DMB tuner 201 selects channels of a predetermined frequency desired by a user and receives the DMB broadcasting signals of the corresponding frequency. The satellite DMB demodulator 202 demodulates the DMB broadcasting signals received in the satellite DMB tuner 201, and outputs a first MPEG 2-TS (MPEG-2 Transport Stream) generated by demodulating the DMB broadcasting signals to the DMB classification unit 205.

The terrestrial DMB tuner 203 selects ensembles of a predetermined frequency desired by the user in the terrestrial DMB and receives the DMB broadcasting signals of the corresponding frequency. An ensemble includes multiple services, and is a basic element constituting DMB signals. It is common that one ensemble may include multiple audio services, video services and data services. The bundle of services in the ensemble is transmitted when a broadcasting frequency is selected. The user selects a service within the ensemble, thereby receiving the specific service. Terrestrial DMB signals include a plurality of unit ensembles.

The terrestrial DMB demodulator 204 demodulates the DMB broadcasting signals received in the terrestrial DMB tuner 203, and outputs, to the DMB classification unit 205, a second MPEG 2-TS generated by demodulating the DMB broadcasting signals. The DMB classification unit 205 receives the first and the second MPEG 2-TSs from the satellite DMB demodulator 202 and the terrestrial DMB demodulator 204, respectively, and switches the first and the second MPEG 2-TSs according to the selection of the user. The unit 205 outputs the switched MPEG 2-TS to at least one of the broadcasting information display unit and the MPEG 2-TS output unit. The storage unit 206 receives and stores the first and the second MPEG 2-TSs output from the DMB classification unit 205. The MPEG 2 demux 207 receives the first and the second MPEG 2-TSs from the DMB classification unit 205, and demuxes the first and the second MPEG 2-TSs. The MPEG 2-TS output unit 208 receives and decodes the first and the second MPEG 2-TS data demuxed by the MPEG 2 demux 207. The controller 209 transfers selection information of the user to the DMB classification unit 205, causes the DMB classification unit 205 to perform a switching operation, and transfers information on the decoding scheme to the MPEG 2-TS output unit 208 according to the switching operation.

In a satellite DMB system and a terrestrial DMB system, a sender for transmitting DMB signals to the DMB terminal of a user compresses and transmits the DMB signals by means of a highly efficient compression algorithm such as MPEG. Digital broadcasting data of multiple compressed programs are multiplexed and transmitted through a satellite gap filler or a terrestrial gap filler as digital broadcasting waves. In particular, the digital broadcasting data are divided into data such as video data and audio data, compressed, split among predetermined units of Transport Packets (TPs), and multiplexed into TSs for transmission. Each TS includes the digital broadcasting data multiplexed for multiple programs, and a user selects and watches a program.

Since the highly efficient compression algorithms such as an MPEG and its transport structures such as MPEG 2-TS, which are used for the satellite DMB system and the terrestrial DMB system, are well known in the communication field, details are omitted herein.

The DMB classification unit 205 switches the first and the second MPEG 2-TSs according to the selection of the user, and stores the switched MPEG 2-TS in the storage unit 206 or transmits the switched MPEG 2-TS to the MPEG 2 demux 207. Through a DMB storage service menu provided by the DMB terminal, the user makes the selection between storing and transmitting.

The first and the second MPEG 2-TSs stored in the storage unit 206 include TAG information used for confirming information of the sender who transmits the DMB signals to the DMB terminal.

When the first and the second MPEG 2-TSs, which include the TAG information and are stored in the storage unit 206, are presented, i.e., rendered or played, at the request of the user, the controller 209 confirms the TAG information. The controller 209 transfers the information on the decoding scheme to the MPEG 2-TS output unit 208 with respect to the first and the second MPEG 2-TSs, which are input to the DMB classification unit 205, according to the confirmed TAG information. Before the TAG information is stored in the storage unit 206, the TAG information is inserted by the broadcasting information display unit of the DMB classification unit 205.

The storage unit 206 receives and stores the first and the second MPEG 2-TSs including the TAG information inserted by the DMB classification unit 205. As mentioned above, the first and the second MPEG 2-TSs including the TAG information are presented at the request of the user. If a presentation request for the first and the second MPEG 2-TSs stored in the storage unit 206 is received from the user, the controller 209 confirms the TAG information of the first and the second MPEG 2-TSs, which have been stored in the storage unit 206, and causes the first and the second MPEG 2-TSs to be transmitted to the DMB classification unit 205.

The MPEG 2 demux 207 receives the first and the second MPEG 2-TSs from the DMB classification unit 205, and demuxes the first and the second MPEG 2-TSs. That is, through the demuxing, the first and the second MPEG 2-TSs are divided into video, audio, supplementary information, etc. The MPEG 2 demux 207 transmits the first and the second MPEG 2-TS data demuxed by the MPEG 2 demux 207 to the MPEG 2-TS output unit 208.

The MPEG 2-TS output unit 208 decodes compressed data in the first and the second MPEG 2-TS data, by means of a predetermined codec, for output when viewing images or presenting sound, etc.

The MPEG 2-TS output unit 208 is preferably realized as a Digital Signal Processor (DSP) which is an integrated circuit capable of processing digital signals by hardware. It downloads a codec suitable for an input MPEG 2-TS in real time, and performs a decoding operation.

If MPEG 2-TS data input from the DMB classification unit 205 is the first MPEG 2-TS data, the MPEG 2-TS output unit 208 downloads an MPEG 2 codec and performs MPEG 2 decoding. However, if MPEG 2-TS data input from the DMB classification unit 205 is the second MPEG 2-TS data, the MPEG 2-TS output unit 208 downloads an MPEG 4 codec and performs MPEG 4 decoding.

If the presentation request for the first and the second MPEG 2-TSs stored in the storage unit 206 is received from the user, the controller 209 confirms the TAG information of the first and the second MPEG 2-TSs stored in the storage unit 206. The controller 209 transfers information on the decoding scheme which is to be performed by the MPEG 2-TS output unit 208. Then, the MPEG 2-TS output unit 208 alters a decoder according to the confirmed TAG information. The controller 209 controls the MPEG 2 -TS output unit 208 to perform corresponding decoding.

As mentioned above, the MPEG 2-TS output unit 208 has both the MPEG 2 codec and the MPEG 4 codec. The output unit 208 includes a switching unit. By means of the switching unit, the output unit 208 performs a switching operation according to the first and the second MPEG 2-TSs of the satellite DMB and the terrestrial DMB, which are input from the MPEG 2 demux 207. The output unit 208 then performs corresponding decoding.

Since the MPEG 2 codec and the MPEG 4 codec for decoding, respectively, the first and the second MPEG 2-TS data are well known in the communication field, details are omitted herein.

The controller 209 transfers the selection information of the user to the DMB classification unit 205, causes the DMB classification unit 205 to perform a switching operation, and transfers information on the decoding scheme to the MPEG 2-TS output unit 208 according to the switching operation. If the first MPEG 2-TS and the second MPEG 2 - are input to the DMB classification unit 205, the controller 209 confirms the selection information of the user, and controls the operation of the DMB classification unit according to the confirmed selection information of the user.

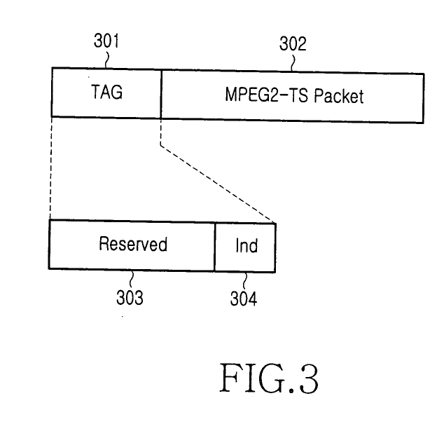

FIG. 3 is a diagram illustrating one example of the format of the MPEG 2-TS including the TAG information according to the present invention.

The MPEG 2-TS is divided into a TAG 301 and an MPEG 2-TS packet 302. The TAG 301 includes information on the sender who transmits, to the DMB terminal, the DMB signals of the first and the second MPEG 2-TSs of the DMB stations, which are stored in the storage unit 206 according to the setup of a user. The MPEG 2-TS packet 302 includes video data, audio data, etc., of the satellite DMB and the terrestrial DMB and has a fixed length of 188 bytes. The TAG 301 is divided into a reserved field 303 and an Ind 304. The reserved field 303 is empty, and serves as a preliminary space. The TAG 301 includes information used for determining if the DMB signals transmitted from the sender to the DMB terminal correspond to satellite DMB signals or terrestrial DMB signals

Since the MPEG 2-TS packet 302 is well known in the communication field, details are omitted herein.

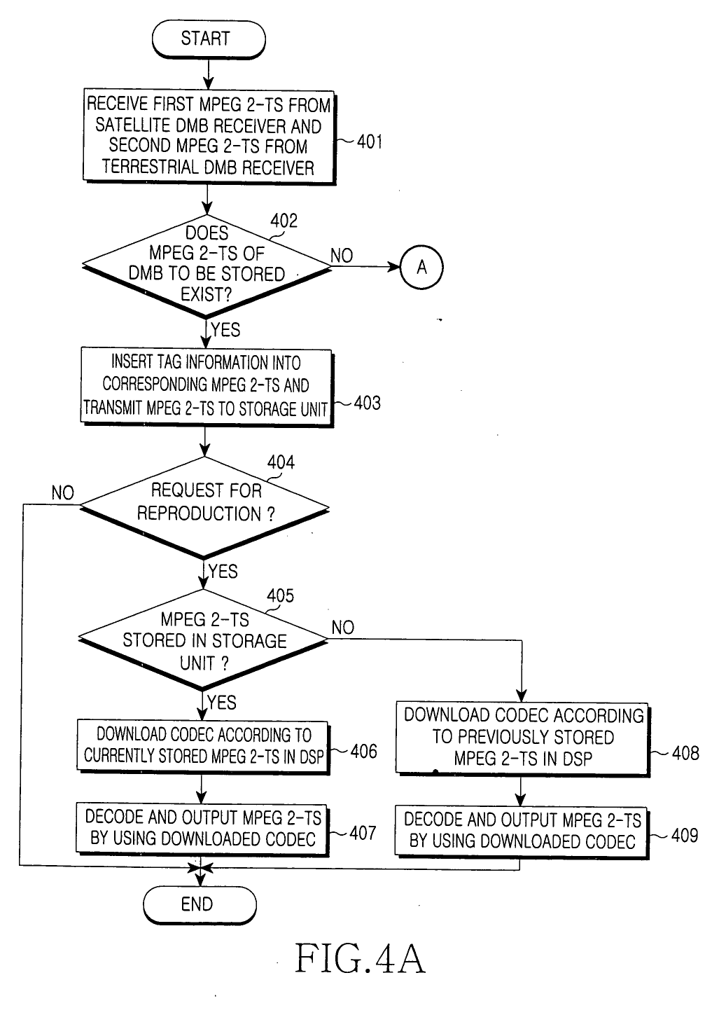

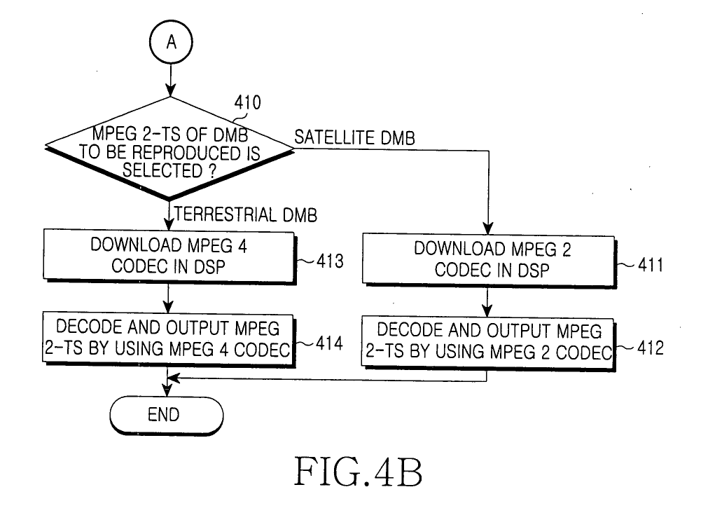

FIGS. 4A and 4B are flow diagrams illustrating a method for simultaneously presenting and recording the satellite DMB and the terrestrial DMB received in the DMB terminal according to the present invention.

If the first MPEG 2-TS from the satellite DMB receiver and the second MPEG 2-TS from the terrestrial DMB receiver are received in the DMB classification unit 205 (401), the controller 209 confirms the setup of a DMB storage service, and determines if there exist MPEG 2-TSs of predetermined DMB systems (e.g., terrestrial or satellite), which are to be stored in the storage unit 206 (402).

If the controller 209 confirms the selection information of the user, and determines that the MPEG 2-TS exists, the DMB classification unit 205 inserts, by means of the broadcasting information display unit, the TAG information having a length of one byte into the MPEG 2-TS of the corresponding DMB system. The unit 205 also, in this case, transmits the MPEG 2-TS including the TAG information to the storage unit 206 (403). If a presentation request is input from the user in a state in which the DMB classification unit 205 stores the MPEG 2-TS of the predetermined DMB system in the storage unit 206 (404), the controller 209 determines whether the MPEG 2-TS for which the presentation has been requested corresponds to the currently stored MPEG 2-TS of the predetermined DMB or the previously stored MPEG 2-TS of the predetermined DMB (405).

If it corresponds to the currently stored MPEG 2-TS of the predetermined DMB, the controller 209 downloads, to the output unit 208, a predetermined codec according to the MPEG 2-TS, which is currently stored in the storage unit 206. Then, the controller 209 uses the downloaded codec to decode and output the MPEG 2-TS data of the predetermined DMB system, which are input to the MPEG 2-TS output unit 208.

If, however, the MPEG 2-TS, for which the presentation has been requested, corresponds to the previously stored MPEG 2-TS of the predetermined DMB, the controller 209 downloads a predetermined codec according to the MPEG 2-TS, and decodes and outputs the MPEG 2-TS data of the predetermined DMB system to the MPEG 2-TS output unit 208, by means of the downloaded codec (409).

As a result of the determination in step 402, if there exists no MPEG 2-TS of the predetermined DMB system, which is to be stored in the storage unit 206, the controller 209 selects, for presentation, an MPEG 2-TS of the DMB system. In particular, the controller 209 selects between the first and the second MPEG 2-TSs of the satellite DMB and the terrestrial DMB, which are input to the DMB classification unit 205 (410). The selection, for presentation, of the MPEG 2-TS of the DMB system is set according to user selection through the menu provided by the DMB terminal.

If the MPEG 2-TS of the satellite DMB system is set to be presented, the controller 209 downloads an MPEG 2 codec, uses it to decode the MPEG 2-TS data, and outputs the result to the MPEG 2-TS output unit 208 (412).

If, however, the MPEG 2-TS of the terrestrial DMB system is set to be presented, the controller 209 downloads an MPEG 4 codec in the DSP (413). Then, the controller 209 decodes and outputs the MPEG 2-TS data of the terrestrial DMB system, which are input to the MPEG 2-TS output unit 208, by means of the MPEG 4 codec downloaded in the DSP (414).

As described above, when there exists no MPEG 2-TS of the DMB system, which is to be stored in the storage unit 206, the MPEG 2-TS to be presented of the predetermined DMB system can simultaneously be presented and recorded at the request of the user.

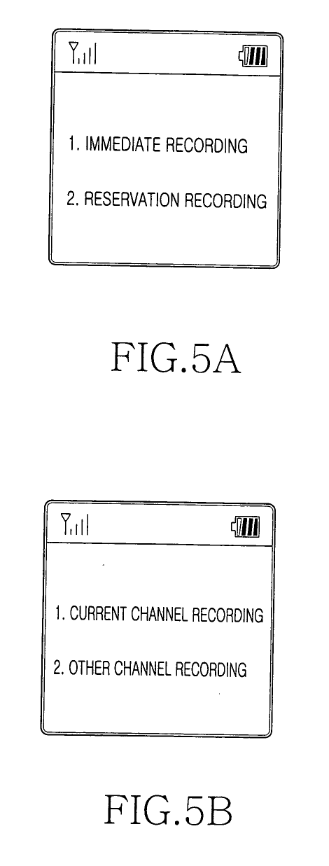

FIG. 5A is an exemplary view illustrating a DMB recording menu screen in the DMB terminal 200 according to one embodiment of the present invention.

When the user presents the MPEG 2-TS, if the user requests recording of the MPEG 2-TS, the DMB recording menu screen as illustrated in FIG. 5A is displayed. In an embodiment of the present invention, a menu screen including a recording service (e.g. “1. immediate recording and “2. reservation recording”) desired by the user is displayed. If the user selects “1. immediate recording” from the menu screen, the recording channel selection menu screen as illustrated in FIG. 5B is displayed. The user may record the program of the DMB system, i.e., a DMB program, the user is currently watching, or may select and record a DMB program by means of the channel selection menu screen in FIG. 5B.

Thus, even when the MPEG 2-TS of a predetermined DMB system stored in the storage unit 206 is presented, the presented MPEG 2-TS of a predetermined DMB system may also be stored in the storage unit 206 while being presented.

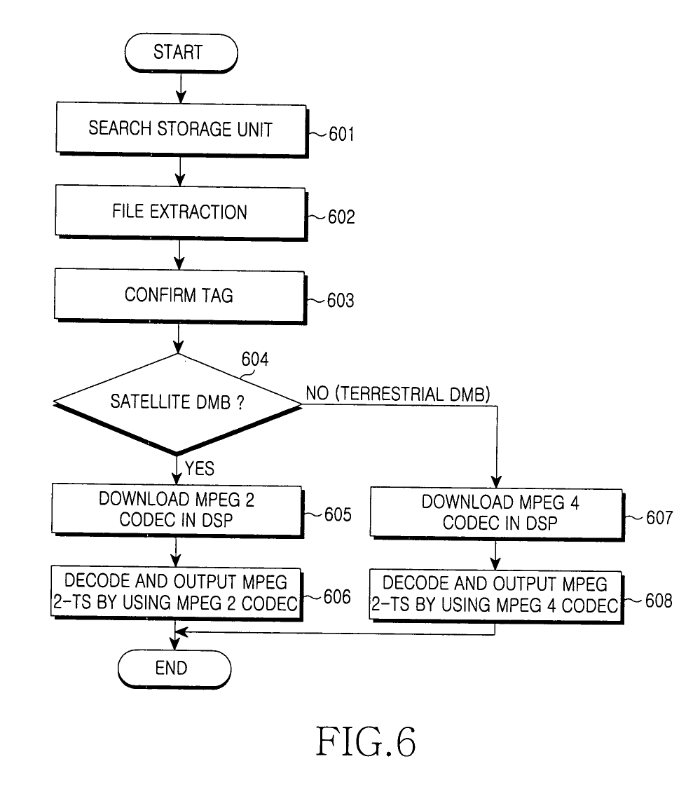

FIG. 6 provides one example illustrating a process for presenting the MPEG 2 -TS stored in the storage unit 206 according to the present invention.

If a presentation request for the MPEG 2-TS of the predetermined DMB system stored in the storage unit 206 is received from a user, the controller 209 extracts the MPEG 2-TS of the predetermined DMB system stored in the storage unit 206 in order to provide the user with the MPEG 2-TS files of the predetermined DMB system stored in the storage unit 206 (601).

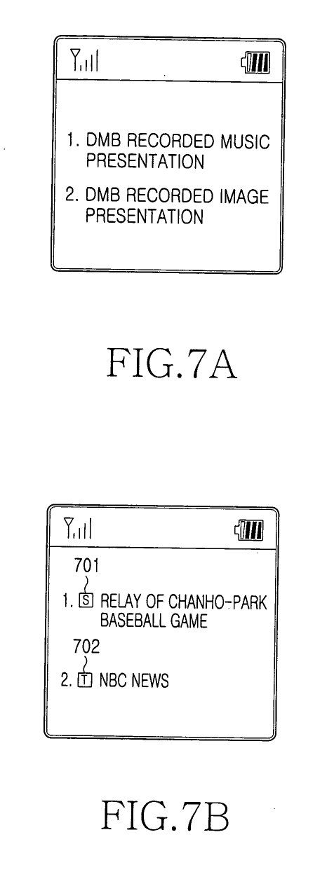

FIGS. 7A and 7B are exemplary views illustrating, by way of example, the menu provided by the DMB terminal in order to afford presentation of the MPEG 2-TS stored in the storage unit 206 according to one embodiment of the present invention.

As illustrated in FIG. 7A, if a user requests recorded image presentation, i.e., that the image(s) be shown, the DMB terminal displays a menu according to category, such as “1. DMB recorded music presentation and 2. DMB recorded image presentation.” The controller 209 extracts and displays, as shown in FIG. 7B (602), the recorded image files in response to menu selection. An embodiment of the present invention exemplifies “1. Relay of a ChanHo-Park baseball game and 2. NBC news.” The reference number 701 represents the choice of ChanHo-Park relay broadcasting file input through the satellite DMB system, and the reference number 702 represents the choice of NBC news file input through the terrestrial DMB system.

If the user selects a recorded image file, which the user wants to present, by means of the menu provided by the DMB terminal as illustrated in FIG. 7B, the controller 209 confirms the TAG of the MPEG 2-TS of the predetermined DMB system, which is selected by the user (603).

If the TAG of the MPEG 2-TS of the predetermined DMB system, which is selected by the user, corresponds to the TAG of the satellite DMB, the controller 209 downloads an MPEG 2 codec in the DSP (602). Then, the controller 209 decodes and outputs the MPEG 2-TS data of the satellite DMB system, which are input to the MPEG 2-TS output unit 208, by means of the MPEG 2 codec downloaded in the DSP (606).

However, if the TAG of the MPEG 2-TS of the predetermined DMB system, which is selected by the user, corresponds to the TAG of the terrestrial DMB, the controller 209 downloads an MPEG 4 codec in the DSP (607). Then, the controller 209 decodes and outputs the MPEG 2-TS data of the terrestrial DMB system, which are input to the MPEG 2-TS output unit 208, by means of the MPEG 4 codec downloaded in the DSP (608).

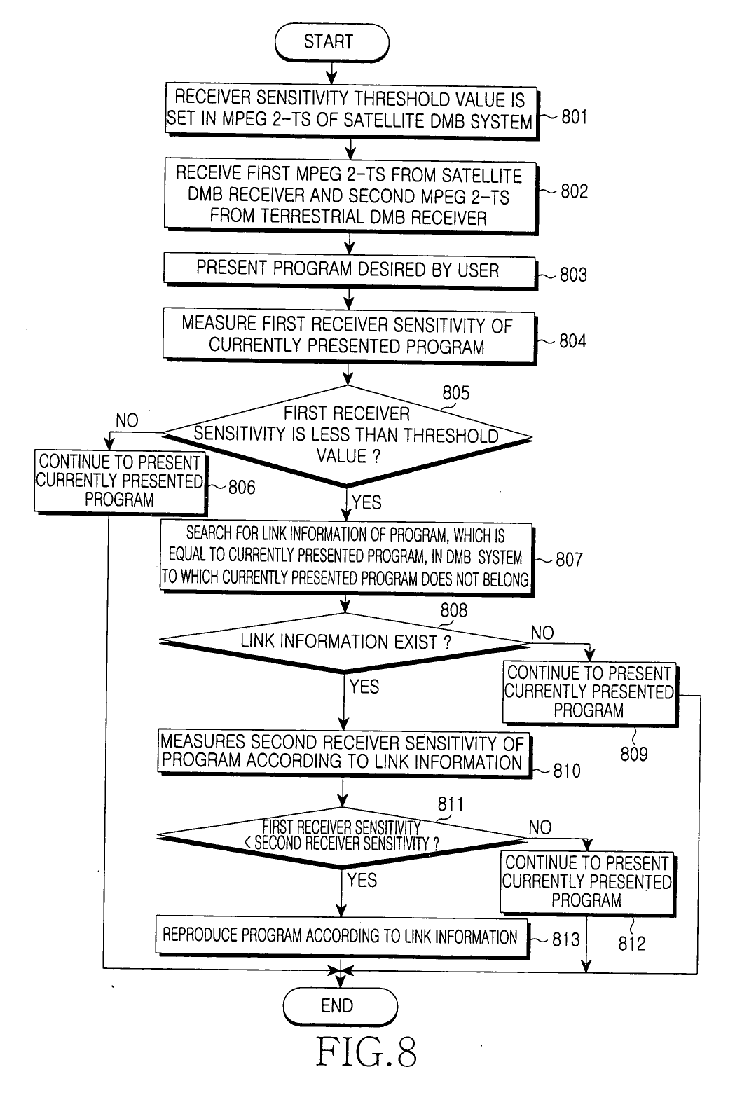

FIG. 8 is shows an exemplary process for finding link information of the same program in the satellite DMB and the terrestrial DMB and providing the link information to a user according to the present invention.

By means of selection on the DMB terminal 200 by the user or, in advance, by the terminal manufacturer, a receiver sensitivity threshold value is set in the MPEG 2-TS of the satellite DMB system and the MPEG 2-TS of the terrestrial DMB system (801). If the first MPEG 2-TS from the satellite DMB receiver and the second MPEG 2-TS from the terrestrial DMB receiver are received in the DMB classification unit 205 (802), the controller 209 presents the program of a predetermined DMB system desired by the user (803). Then, the controller 209 measures the receiver sensitivity of the currently presented program of a predetermined DMB system (804).

If the measured receiver sensitivity is less than the threshold value set in the DMB terminal (805), the controller 209 searches for link information of a program, which corresponds to the currently presented program, in a DMB system to which the currently presented program does not belong (807). When the satellite DMB system and the terrestrial DMB system are broadcasting the same program at the same time, the link information is for enabling the program of the satellite DMB system and the terrestrial DMB system to be simultaneously provided to the user.

In the present invention, the link information preferably serves to enable a program currently being watched by the user to be provided without interruption. In particular, if the user, while in motion, watches the program of a DMB system, and the satellite DMB system and the terrestrial DMB system are broadcasting the same program at the same time, the controller 209 measures the receiver sensitivity of the currently presented program of the DMB system. The controller 209 finds and presents the same program from a DMB system, which is not currently presented, if the measured receiver sensitivity is less than the threshold value set in the DMB terminal.

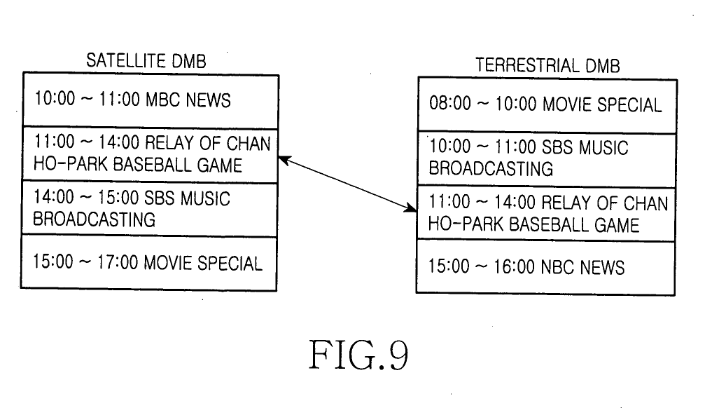

Such link information can be obtained by the controller 209 by searching for the EPG of the satellite DMB system and the EPG text information of the terrestrial DMB system, which are provided in the DMB terminal of FIG. 9. It is possible to set corresponding link information to be provided to the DMB terminal from the EPG information provided to the DMB terminal from a DMB contents provider which supplies DMB contents.

FIG. 9 is an exemplary view illustrating link information of the same program in the satellite DMB system and the terrestrial DMB system of FIG. 8.

As illustrated in FIG. 9, when a user moves and watches the relay of a ChanHo-Park baseball game, which is provided by the satellite DMB system, by means of the DMB terminal capable of simultaneously receiving the satellite DMB and the terrestrial DMB according to the present invention, the controller 209 measures a first receiver sensitivity of the currently presented program of the satellite DMB system (804).

If the measured receiver sensitivity is less than the threshold value of receiver sensitivity set in the DMB terminal (805), the controller 209 searches for the same program in a DMB system, to which the currently presented program does not belong, i.e. in the EPG information of the terrestrial DMB as illustrated in FIG. 9 (807). If there is no link information as a result of step 807 (808), the controller 209 continues to present the ChanHo-Park baseball game relay broadcasting program of the satellite DMB being currently presented (809).

If, however, link information of the same program of the satellite DMB system, which is being currently presented (808), is found, the controller 209 measures a second receiver sensitivity of the program according to the link information (810). The controller 209 compares the second receiver sensitivity with the first receiver sensitivity (811). If the comparison result is that the first receiver sensitivity is less than the second receiver sensitivity, the controller 209 presents the program according to the link information, i.e., the program, which is equal to the currently presented program, in a DMB system to which the currently presented program does not belong (813). If, on the other hand, the second receiver sensitivity is less than the first receiver sensitivity (811), the controller 209 continues to present the currently presented program (812).

In this way, in the present invention, receivers for receiving a satellite DMB and a terrestrial DMB are integrated into a single receiver, so that it is possible to receive various contents transmitted through satellite and terrestrial waves regardless of a transmission medium, and one of input satellite and terrestrial DMB programs can be presented and the other can be recorded.

According to the present invention as described above, receivers for receiving a satellite DMB and a terrestrial DMB are integrated into a single receiver, so that it is possible to receive various content transmitted through satellite and terrestrial waves regardless of a transmission medium. Further, the demux and the decoder of the integrated receiver are used, so that a low cost design is possible, and one of satellite and terrestrial DMB programs can be presented and the other can be recorded.

Although preferred embodiments of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A dual mode Digital Multimedia Broadcasting (DMB) terminal capable of simultaneously receiving broadcasting signals of a satellite DMB station and broadcasting signals of a terrestrial DMB station, the dual mode DMB terminal comprising:
a satellite DMB receiver for receiving and demodulating the broadcasting signals of the satellite DMB, and outputting a first Motion Pictures Expert Group 2 Transport Stream (MPEG 2-TS) generated by demodulating the broadcasting signals;
a terrestrial DMB receiver for receiving and demodulating the broadcasting signals of the terrestrial DMB, and outputting a second MPEG 2-TS generated by demodulating the broadcasting signals;
a DMB classification unit for receiving the first MPEG 2-TS from the satellite DMB receiver, receiving the second MPEG 2-TS from the terrestrial DMB receiver, switching the first MPEG 2-TS and the second MPEG 2-TS according to selection of a user, and outputting the switched MPEG 2-TS to at least one of a broadcasting information display unit and an MPEG 2-TS output unit;
said broadcasting information display unit, for generating TAG information according to whether the MPEG 2-TS input from the DMB classification unit is the first MPEG 2-TS or the second MPEG 2-TS, and inserting the TAG information into the MPEG 2-TS;
a storage unit for receiving the MPEG 2-TS including the TAG information from the broadcasting information display unit, and storing the MPEG 2-TS;
said MPEG 2-TS output unit, for decoding the MPEG 2-TS input from the DMB classification unit according to whether the input MPEG 2-TS is the first MPEG 2-TS or the second MPEG 2-TS, and outputting the decoded MPEG 2-TS; and
a controller for transferring selection information of the user to the DMB classification unit, causing the DMB classification unit to perform a switching operation, and transferring information on a decoding scheme to the MPEG 2-TS output unit according to the switching operation.

2. The dual mode DMB terminal as claimed in claim 1, wherein the controller searches for MPEG 2-TSs stored in the storage unit, causes a predetermined MPEG 2-TS selected as a result of the searching to be output to the DMB classification unit, receives, from the DMB classification unit, the TAG information that has been inserted into the predetermined MPEG 2-TS, transfers the TAG information to the MPEG 2-TS output unit, and determines a decoding scheme to be executed by the MPEG 2-TS output unit.

3. The dual mode DMB terminal as claimed in claim 2, wherein the MPEG 2-TS output unit comprises a digital signal processor (DSP), downloads, in real time, a codec suitable for the MPEG 2-TS inputted by the MPEG 2-TS output unit, and performs the decoding scheme.

4. The dual mode DMB terminal as claimed in claim 3, wherein the MPEG 2-TS output unit downloads an MPEG 2 codec in real time, and the performing of the decoding scheme comprises performing MPEG 2 decoding when the MPEG 2-TS input from the DMB classification unit is the first MPEG 2-TS.

5. The dual mode DMB terminal as claimed in claim 3, wherein the MPEG 2-TS output unit downloads an MPEG 4 codec in real time, and the performing of the decoding scheme comprises performing MPEG 4 decoding when the MPEG 2-TS input from the DMB classification unit is the second MPEG 2-TS.

6. The dual mode DMB terminal as claimed in claim 2, wherein the MPEG 2-TS output unit comprises:
an MPEG 2 decoder for performing MPEG 2 decoding according to an MPEG 2 codec;
an MPEG 4 decoder for performing MPEG 4 decoding according to an MPEG 4 codec; and
a switch unit for transferring the MPEG 2-TS input from the DMB classification unit to the MPEG 2 decoder when the MPEG 2-TS input is the first MPEG 2-TS, and for transferring the MPEG 2-TS input from the DMB classification unit to the MPEG 4 decoder when the MPEG 2-TS input is the second MPEG 2-TS.

7. The dual mode DMB terminal as claimed in claim 1, wherein the MPEG 2-TS output unit comprises a digital signal processor (DSP), downloads, in real time, a codec suitable for the MPEG 2-TS inputted by the MPEG 2-TS output unit, and performs the decoding scheme.

8. The dual mode DMB terminal as claimed in claim 1, wherein the MPEG 2-TS output unit comprises:
an MPEG 2 decoder for performing MPEG 2 decoding according to an MPEG 2 codec;
an MPEG 4 decoder for performing MPEG 4 decoding according to an MPEG 4 codec; and
a switch unit for transferring the MPEG 2-TS input from the DMB classification unit to the MPEG 2 decoder when the MPEG 2-TS input is the first MPEG 2-TS, and for transferring the MPEG 2-TS input from the DMB classification unit to the MPEG 4 decoder when the MPEG 2-TS input is the second MPEG 2-TS.

9. A method for controlling a dual mode Digital Multimedia Broadcasting (DMB) terminal capable of simultaneously receiving broadcasting signals of a satellite DMB station and broadcasting signals of a terrestrial DMB station, the method comprising:
a first step of receiving a first MPEG 2-TS generated by demodulating the broadcasting signals of the satellite DMB, and a second MPEG 2-TS generated by demodulating the broadcasting signals of the terrestrial DMB;
a second step of determining, by a controller of said dual mode DMB terminal configured for simultaneously receiving broadcasting signals of a satellite DMB station and broadcasting signals of a terrestrial DMB station, if the first MPEG 2-TS or the second MPEG 2-TS is to be stored; and
a third step of, when the second step determines the first MPEG 2-TS to be stored, inserting, into the first MPEG 2-TS, a TAG representing a storage format of the first MPEG 2-TS.

10. The method as claimed in claim 9, further comprising:
a fourth step of determining if the first MPEG 2-TS or the second MPEG 2-TS is to be presented; and
a fifth step of, when the second MPEG 2-TS is determined to be presented in the fourth step, applying a decoding scheme suitable for a format of the second MPEG 2-TS to the second MPEG 2-TS.

11. The method as claimed in claim 10, wherein, in the fifth step, when the presented MPEG 2-TS is the first MPEG 2-TS, decoding the first MPEG 2-TS according to an MPEG 2 codec.

12. The method as claimed in claim 10, wherein, in the fifth step, when the presented MPEG 2-TS is the second MPEG 2-TS, decoding the second MPEG 2-TS according to an MPEG 4 codec.

13. A method for measuring receiver sensitivity and providing Digital Multimedia Broadcasting (DMB) in a dual mode DMB terminal capable of simultaneously receiving broadcasting signals of a satellite DMB and broadcasting signals of a terrestrial DMB, the method comprising:
a first step of receiving the broadcasting signals of the satellite DMB and the broadcasting signals of the terrestrial DMB, and outputting a first predetermined broadcast program according to one of the satellite DMB and terrestrial DMB;
a second step of measuring, by said dual mode DMB terminal configured for simultaneously receiving broadcasting signals of a satellite DMB station and broadcasting signals of a terrestrial DMB station, receiver sensitivity of the first predetermined broadcast program;
a third step of comparing the measured receiver sensitivity of the first predetermined broadcast program with a previously set threshold value of the receiver sensitivity, determining if a second predetermined broadcast program linked to the first predetermined broadcast program exists in a DMB system, to which the first predetermined broadcast program does not belong, when the measured receiver sensitivity is less than the threshold value;
a fourth step of measuring receiver sensitivity of the second predetermined broadcast program;
a fifth step of comparing the measured receiver sensitivity of the first predetermined broadcast program with the measured receiver sensitivity of the second predetermined broadcast program; and
a sixth step of selecting, between the two programs compared, a program for presentation, such that, for the program selected, the measured receiver sensitivity is not lower than that of the other.
